(19) United States
(12) Patent Application Publication
(10) Pub. No.: US 2026/0366905 A1
(43) Pub. Date: Nov. 19, 2026

(54) SYSTEMS AND METHODS FOR ESTIMATING CENTER OF GRAVITY FOR ELECTRIC VEHICLES WITH ANTI-PITCH SUSPENSION GEOMETRY

(71) Applicants: Hyundai Motor Company, Seoul (KR); Kia Corporation, Seoul (KR)

(72) Inventors: John Harber, Superior Township, MI (US); Brian Link, Superior Township, MI (US); Justin Holmer, Ann Arbor, MI (US); Arash Hosseinian Ahangarnejad, Superior Township, MI (US); Young Il Kim, Hwaseong (KR); Lance McLaws, Superior Township, MI (US)

(21) Appl. No.: 19/212,471

(22) Filed: May 19, 2025

(51) Int. Cl. G01G 19/02

(52) U.S. Cl. CPC G01G 19/02

(57) ABSTRACT

Systems and methods for estimating a center of gravity (CG) for a vehicle are provided. The method may comprise estimating a longitudinal and lateral CG of the vehicle, comprising determining whether the vehicle is stopped, estimating a vertical load on the vehicle, and estimating the longitudinal and lateral CGs of the vehicle based on the vertical load. The method may comprise estimating a vertical CG of the vehicle, comprising determining whether there is a longitudinal dynamic event happening to the vehicle, estimating a vertical load on a front axle and rear axle of the vehicle, estimating a front vertical CG of the vehicle based on the vertical load on the front axle, estimating a rear vertical CG of the vehicle based on the vertical load on the rear axle, and averaging the front and rear vertical CGs of the vehicle to estimate the vertical CG of the vehicle.

### BACKGROUND

### Technical Field

Embodiments of the present disclosure relate to systems and methods for estimating center of gravity for electric vehicles (EVs) with anti-pitch suspension geometry.

### Background

Electric vehicle (EV) control algorithms are limited based on the lack of certain vehicle information influencing load transfer under accelerations. This limitation can lead to decreased regenerative braking usage, premature wheel slip control intervention, and decreased advanced driver assistance systems (ADAS) intervention effectiveness.

The load transfer when a vehicle brakes, accelerates, or turns greatly affects vehicle performance and, therefore, safety. The amount of load transfer that occurs is a function of several constant vehicle parameters, such as track-width and wheelbase, as well as two variable/unknown parameters: acceleration and center of gravity (CG) location. While the CG of an empty vehicle is known by the original equipment manufacturer (OEM), the actual CG location of any given car on the road cannot always be assumed given the varying loads carried by the vehicle.

Accelerometers are generally used to estimate the forces accelerating a vehicle. However, this presents several problems, particularly when including the effect of anti-pitch geometries into estimation algorithms for EVs.

Nearly all road vehicles have some degree of kinematic “anti-pitch” effect designed in their suspension. This lessens the amount of suspension travel that occurs due to changes in vehicle speed. Since the suspension compresses less if a stroke sensor is estimating a vertical load based on suspension travel, these estimations will be incorrect on vehicles with anti-pitch effects, as the vehicle's vertical load will be underestimated on the laden axle. This error results in an under-estimation of CG height, thus leading to a situation where the control system determines that the vehicle is capable of higher performance than it actually is.

This effect is particularly important for EVs because the governing equations for anti-pitch load transfer differs between inboard (chassis mounted electric motors) and outboard (in-wheel motors, friction brakes) torque sources. EVs use a combination of both methods, making it impossible to accurately account for longitudinal kinematic effects based on acceleration alone since that sensor cannot differentiate between the torque sources.

### SUMMARY

According to an object of the present disclosure, a method for estimating a center of gravity (CG) for a vehicle is provided.

In one aspect, a method for estimating a center of gravity (CG) for a vehicle s provided and suitably includes: a) estimating a longitudinal CG and a lateral CG of the vehicle; and b) estimating a vertical CG of the vehicle, to thereby estimate a center of gravity (CG) for the vehicle using a computing device. Suitably, the method includes using a computing device comprising a processor and a memory.

In a further aspect, the method may comprise estimating a longitudinal CG and a lateral CG of the vehicle, comprising determining, using a computing device comprising a processor and a memory, whether the vehicle is stopped, when the vehicle is stopped, estimating a vertical load on the vehicle, estimating the longitudinal CG of the vehicle based on the vertical load, and estimating the lateral CG of the vehicle based on the vertical load. The method may comprise estimating a vertical CG of the vehicle, comprising determining, using the computing device, whether there is a longitudinal dynamic event happening to the vehicle, when there is a longitudinal dynamic event happening to the vehicle, estimating a vertical load on a front axle of the vehicle and a rear axle of the vehicle, estimating a front vertical CG of the vehicle based on the vertical load on the front axle, estimating a rear vertical CG of the vehicle based on the vertical load on the rear axle, and averaging the front vertical CG of the vehicle and the rear vertical CG of the vehicle to estimate the vertical CG of the vehicle.

According to an exemplary embodiment, the method may comprise determining whether the vehicle is in drive.

According to an exemplary embodiment, the estimating the vertical load on the vehicle, when the vehicle is stopped, may comprise measuring wheel displacement from one or more stroke sensors coupled to the vehicle.

According to an exemplary embodiment, the estimating the longitudinal CG and the lateral CG of the vehicle may comprise performing a vertical load correction based on one or more of the following: a slope of the vehicle; a banking of a road on which the vehicle is driving; a speed of the vehicle; and a mass of the vehicle.

According to an exemplary embodiment, the estimating the vertical CG of the vehicle may comprise estimating, using the computing device, one or more static loading conditions.

According to an exemplary embodiment, the estimating the vertical load on the vehicle, when there is a longitudinal dynamic event happening to the vehicle, may comprise measuring wheel displacement from one or more stroke sensors coupled to the vehicle.

According to an exemplary embodiment, the longitudinal dynamic event may comprise one or more of: a braking event; and an accelerating event.

According to an exemplary embodiment, the vehicle may comprise an electric vehicle.

According to an object of the present disclosure, a system for estimating a CG for a vehicle is provided. The system may comprise a vehicle and a computing device comprising a processor and a memory. The memory may be configured to store instructions that, when executed by the processor, are configured to cause the processor to estimate a longitudinal CG and a lateral CG of the vehicle, comprising determining, using a computing device comprising a processor and a memory, whether the vehicle is stopped, when the vehicle is stopped, estimating a vertical load on the vehicle, estimating the longitudinal CG of the vehicle based on the vertical load, and estimating the lateral CG of the vehicle based on the vertical load, and estimate a vertical CG of the vehicle, comprising determining, using the computing device, whether there is a longitudinal dynamic event happening to the vehicle, when there is a longitudinal dynamic event happening to the vehicle, estimating a vertical load on a front axle of the vehicle and a rear axle of the vehicle, estimating a front vertical CG of the vehicle based on the vertical load on the front axle, estimating a rear vertical CG of the vehicle based on the vertical load on the rear axle, and averaging the front vertical CG of the vehicle and the rear vertical CG of the vehicle to estimate the vertical CG of the vehicle.

According to an exemplary embodiment, the instructions, when executed by the processor, may be configured to cause the processor to determine whether the vehicle is in drive.

According to an exemplary embodiment, the system may comprise one or more stroke sensors coupled to the vehicle.

According to an exemplary embodiment, the estimating the vertical load on the vehicle, when the vehicle is stopped, may comprise measuring wheel displacement from the one or more stroke sensors coupled to the vehicle.

According to an exemplary embodiment, the estimating the vertical load on the vehicle, when there is a longitudinal dynamic event happening to the vehicle, may comprise measuring wheel displacement from the one or more stroke sensors coupled to the vehicle.

According to an exemplary embodiment, the estimating the longitudinal CG and the lateral CG of the vehicle may comprise performing a vertical load correction based on one or more of the following: a slope of the vehicle; a banking of a road on which the vehicle is driving; a speed of the vehicle; and a mass of the vehicle.

According to an exemplary embodiment, the estimating the vertical CG of the vehicle may comprise estimating, using the computing device, one or more static loading conditions.

According to an exemplary embodiment, the longitudinal dynamic event may comprise one or more of: a braking event; and an accelerating event.

According to an exemplary embodiment, the vehicle may comprise an electric vehicle.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates an example system for estimating the center of gravity (CG) of a vehicle, according to an exemplary embodiment of the present disclosure.

FIGS. 2A-2B illustrate flowcharts of an example method for estimating the CG of a vehicle, according to an exemplary embodiment of the present disclosure.

FIGS. 3A-3B illustrate a side view (FIG. 3A) and front view (FIG. 3B) of a vehicle, according to an exemplary embodiment of the present disclosure.

FIG. 4 illustrates a side view of a vehicle, according to an exemplary embodiment of the present disclosure.

FIG. 5 illustrates an example architecture of a vehicle, according to an exemplary embodiment of the present disclosure.

FIG. 6 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for estimating the center of gravity (CG) for electric vehicles (EVs) with anti-pitch suspension geometry are provided.

According to an exemplary embodiment, one or more wheel stroke sensors and estimated motor torque values may be used alongside known suspension characteristics such as, e.g., spring rates, damping rates, and kinematic values to estimate the center of gravity (CG) locations in the lateral, longitudinal, and vertical directions. The lateral and longitudinal center CG locations may be determined while the vehicle is at a stop using, e.g., stroke sensors and suspension/vehicle characteristics, Vertical location may be estimated during braking and/or accelerating by first estimating the load transfer for a given torque output and then finding the necessary CG height to achieve that load transfer.

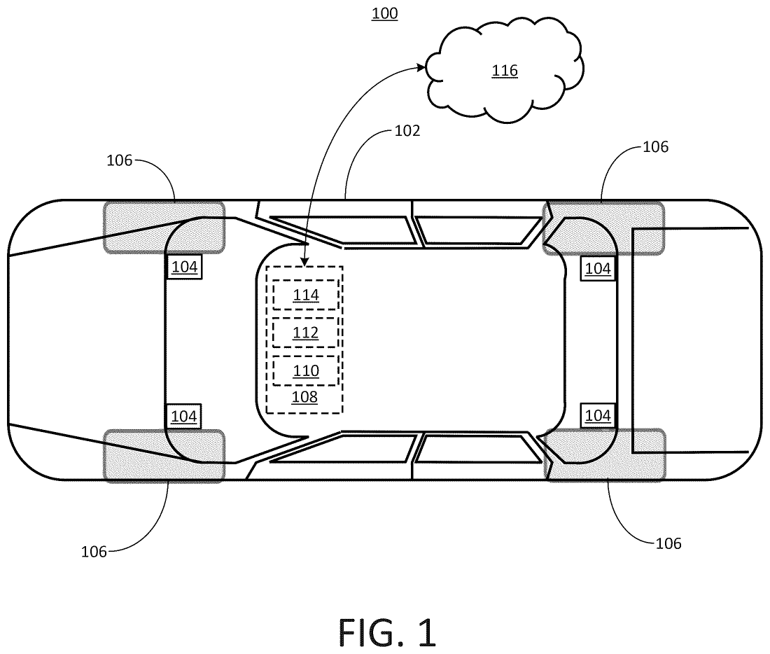

Referring now to FIG. 1, a system 100 for estimating the CG for EVs with anti-pitch suspension geometry is illustratively depicted, in accordance with an exemplary embodiment of the present disclosure.

According to an exemplary embodiment, the system 100 may comprise a vehicle 102. The vehicle 102 may comprise an EV and/or other suitable vehicle.

According to an exemplary embodiment, the vehicle 102 may comprise one or more stroke sensors 104. The one or more stroke sensors 104 may be configured to sense wheel displacement of one or more wheels 106 of the vehicle 102.

According to an exemplary embodiment, the vehicle 102 may comprise a computing device 108. The computing device 108 may comprise a processor 110, a memory 112, and/or a user interface 114 (e.g., a graphical user interface). The computing device 108 may be configured to send and/or receive commands/data/input/etc. via one or more external systems via wired and/or wireless connection (e.g., via the cloud 116).

According to an exemplary embodiment, the one or more stroke sensors 104 and/or other components of the vehicle 102 may be configured to communicate with the vehicle 102 via the cloud 116, the one or more computing devices 108, and/or other suitable means.

The memory 112 may be configured to store programming instructions that, when executed by the processor 110, may be configured to cause the processor 110 to perform one or more tasks such as, e.g., determining whether the vehicle 102 is in drive, determining whether the vehicle 102 is parked, reading, storing, and/or analyzing one or more data points measured by the one or more stroke sensors 104 to determine wheel 106 displacement, determining a vertical load of the vehicle 102, determining a lateral CG position of the vehicle 102, determining a longitudinal CG position of the vehicle 102, determining a vertical CG position of the vehicle 102, determining an estimated CG of the vehicle 102, and/or performing one or more other suitable tasks.

The location of the CG of the vehicle 102 affects the driving capabilities and user enjoyment of the vehicle 102. For example, the more the CG is positioned near the top of the vehicle 102, the more the vehicle's 102 braking capabilities and cornering capabilities decrease and the more the vehicle's 102 rollover risk and cabin movement increase. Conversely, the more the CG is positioned near the bottom of the vehicle 102, the more the vehicle's 102 braking capabilities and cornering capabilities increase and the more the vehicle's 102 rollover risk and cabin movement decrease. The more the CG is positioned near the front of the vehicle 102, the more the vehicle's 102 braking capabilities decrease and the more the vehicle's 102 yaw stability and front wheel traction increase. Conversely, the more the CG is positioned near the rear of the vehicle 102, the more the vehicle's 102 braking capabilities and rear wheel traction increase and the more the vehicle's 102 yaw stability decreases. According to an exemplary embodiment, the vehicle 102 may comprise one or more inertial measurement units (IMUs) 118. The IMU 118 may be coupled to, a component of, or separate from the computing device 108.

According to an exemplary embodiment, the system 100 may be configured to estimate the CG location of the vehicle 102 given any loading condition using a combination of the one or more wheel stroke sensors 104 and motor torque demands. This process may be split between two separate tasks: (1) determining the lateral/longitudinal CG of the vehicle 102; and (2) determining the vertical CG of the vehicle 102.

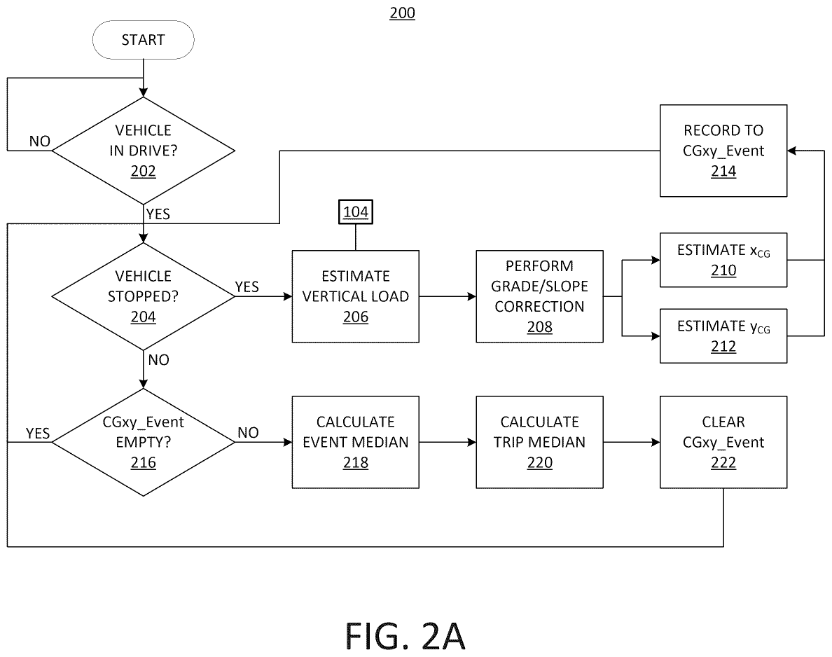

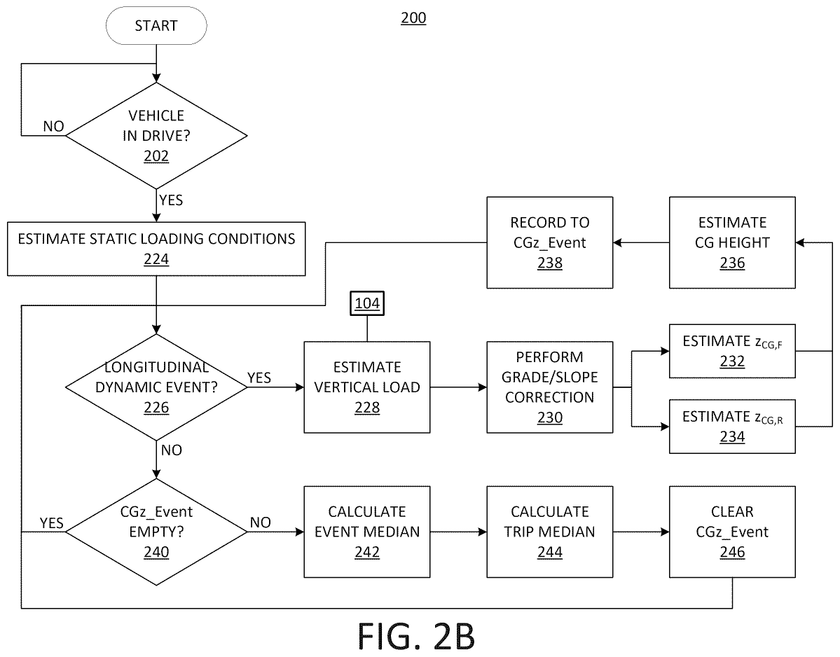

Referring now to FIG. 2A, a flowchart of the method 200 for determining the lateral/longitudinal CG for a vehicle is illustratively depicted, in accordance with an exemplary embodiment of the present disclosure.

According to an exemplary embodiment, lateral and longitudinal CG (CG_{X/Y}) position determination may occur when the vehicle is stationary with all doors closed (i.e., during a stopped event). At 202, all variables may be reset and zeroed out. It may then be determined, at 204, whether a vehicle is stopped (i.e., whether the vehicle's speed is zero).

When the vehicle is stopped, then, at 206, a vertical load (i.e., a load placed on the tires/wheels) may be estimated for a current timestamp. According to an exemplary embodiment, wheel displacement from one or more stroke sensors 104 may be read and, using known parameters such, e.g., spring and anti-rollbar (ARB) stiffnesses, the vertical load on each tire may be estimated. Processing of the data may comprise using basic statistics to filter out abnormalities such as movement in cabin and uneven road surfaces.

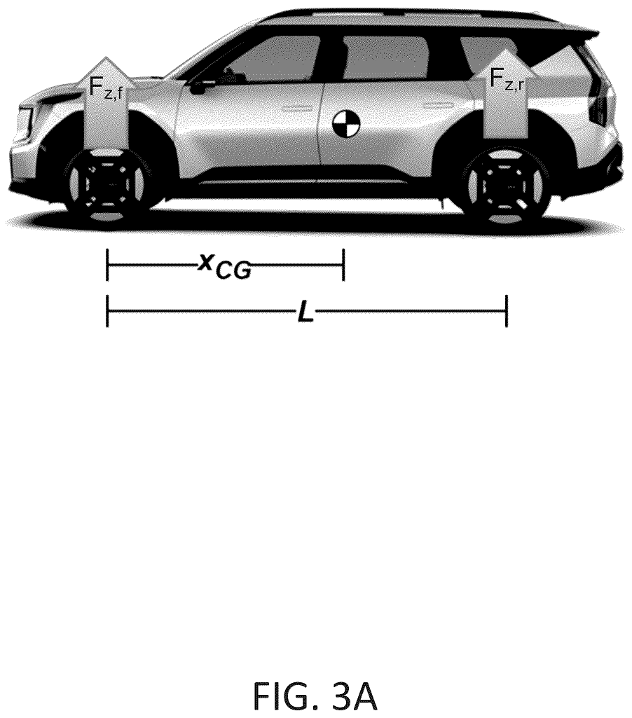

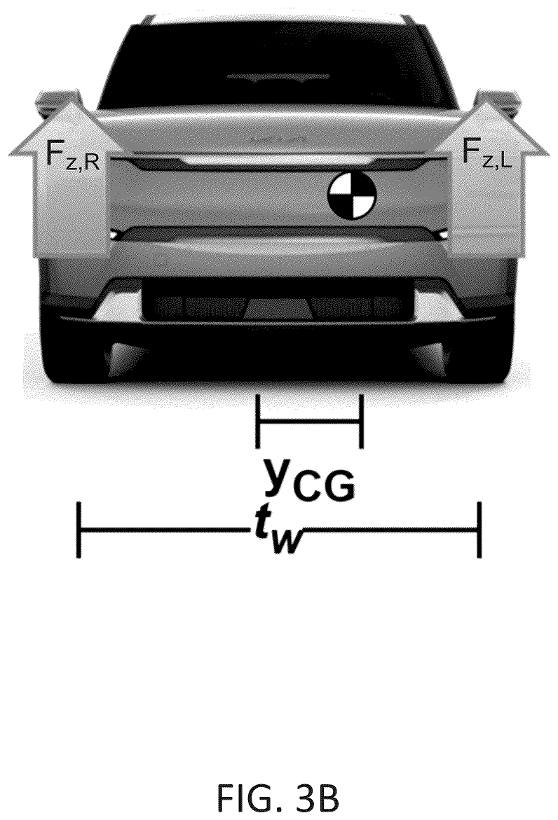

At 208, a correction to the vertical load may be made based on the road grade or slope. According to an exemplary embodiment, the road's slope, the road's banking, the vehicle's speed, and the vehicle's mass may be known or measured using suitable means. According to an exemplary embodiment, an IMU 118 may be used to estimate an angle of the vehicle based, e.g., on finding the component of the gravitational acceleration that has “leaked” into the X- and Y-axis and/or via other suitable means (e.g., map and location data, etc.). This estimated vertical load may then be used to calculate the estimated CG using a basic sum of forces and sum of moments calculations, according to Equation 1 and Equation 2, to estimate the CG in the x-direction (x_{CG}), at 210, and estimate the CG in the y-direction (y_{CG}), at 212.

$${x}_{CG} = \frac{{F}_{z , r} \cdot L}{{F}_{z , f} + {F}_{z , r}} \qquad Equation 1$$

$${y}_{CG} \frac{= {F}_{z , L} \cdot {t}_{w}}{{F}_{z , L} + {F}_{z , R}} - \frac{{t}_{w}}{2} \qquad Equation 2$$

Where L is the wheelbase length of the vehicle, t_{w} is the track width of the vehicle, F_{z,f} is sum of front left and front right vertical loads, F_{z,r} is the sum of rear left and rear right vertical loads, F_{z,L} is the sum of front left and rear left vertical loads, and F_{z,R} is the sum of front right and rear right vertical loads, as shown, e.g., in FIGS. 3A-3B.

According to an exemplary embodiment, multiple x_{CG} and y_{CG} values may be estimated during each stopped event and recorded/appended into an Nx2 array called a CGxy_Event, at 214. According to an exemplary embodiment, the first column of the Nx2 array may contain the x-position estimation, x_{CG}, while the second column may contain the y-position estimation, y_{CG}. It may then be determined, at 204, whether the vehicle is stopped.

When the vehicle is not stopped (i.e., when the vehicle is no longer at rest), it may be determined, at 216, whether are enough data points in the CGxy_Event to have a statistically meaningful sample (i.e., the number of data points in the CGxy_Event is greater than a threshold).

When there are enough data points in the CGxy_Event to have a statistically meaningful sample, then, at 218, a median value of each column in the CGxy_Event may be calculated and added/appended to another Nx2 array called a CGxy_Trip, at 220. The CGxy_Trip is an array of the median estimates for each stopped event for a trip. According to an exemplary embodiment, a running median may be re-evaluated/calculated, at 222, each time a new value is added to the array, calculating the trip median for x_{CG} and y_{CG}. The current running median in the x and y directions may be output, at 224 and the CGxy_Event and the number of data points in the CGxy_Event may be reset, at 226.

When there are not enough data points in the CGxy_Event to have a statistically meaningful sample, then, at 226, the CGxy_Event and the number of data points in the CGxy_Event may be reset.

According to an exemplary embodiment, certain conditions may reset CGxy_Trip while the vehicle is on. According to an exemplary embodiment, at 228, it may be determined whether there are any static loading conditions (e.g., whether the vehicle is in park, whether a door is open (a significant change in estimated mass or distribution may occur after a door had been opened), and/or other static loading conditions). When there are any static loading conditions then, at 230, the CGxy_Trip may be reset and it may then be determined, at 204, whether the vehicle is stopped. When there are not any static loading conditions then it may then be determined, at 204, whether the vehicle is stopped.

Referring now to FIGS. 2B-2C, a flowchart of the method 200 for determining the vertical CG for a vehicle with anti-pitch suspension geometry is illustratively depicted, in accordance with an exemplary embodiment of the present disclosure.

According to an exemplary embodiment, vertical CG (CG_{Z}) position estimation may take place during acceleration and braking events in straight lines. At 202, all variables may be reset and zeroed out. Once all variables have been reset, it may be set that any static loading conditions have not been evaluated, at 232.

At 234, it may be determined whether the vehicle is in drive. When the vehicle is in drive, then, at 204, it may be determined whether a vehicle is stopped (i.e., whether the vehicle's speed is zero).

When the vehicle is stopped, then, at 236, axle loads may be estimated. According to an exemplary embodiment, wheel displacement from one or more stroke sensors 104 may be read to estimate load transfers from suspension movement and determine the axle loads. Processing of the data may comprise using basic statistics to filter out abnormalities such as movement in cabin and uneven road surfaces. According to an exemplary embodiment, motor torque and/or estimated friction brake torque requests may be utilized to estimate load transferred kinematically.

At 208, a correction to the vertical load may be made based on the road grade or slope. According to an exemplary embodiment, the road's slope, the road's banking, the vehicle's speed, and the vehicle's mass may be known or measured using suitable means. According to an exemplary embodiment, an IMU 118 may be used to estimate an angle of the vehicle based, e.g., on finding the component of the gravitational acceleration that has “leaked” into the X- and Y-axis and/or via other suitable means (e.g., map and location data, etc.).

This estimated vertical load may then be used to calculate the estimated z-direction CG, using sensor signals from both the front and rear axles as inputs. The results from each axle may be averaged together to give a single estimated CG height (i.e., CG in the z-direction) at each datapoint. Using these results from each axle, the CG in the z-direction for the front of the vehicle may be estimated using the CG for the front axle (z_{CG,F}), and the CG in the z-direction for the rear of the vehicle may be estimated using the CG for the rear axle (z_{CG,R}). At 238, the results from each axle may be averaged together to give a single estimated CG height at each datapoint, which may be appended to Fz_AxleEvent, an array to log the recorded load on each axle for every timestep during a static loading update event. A new value may be appended to the array at every timestep. This array is reset every time a static loading update event is exited (Speed>0).

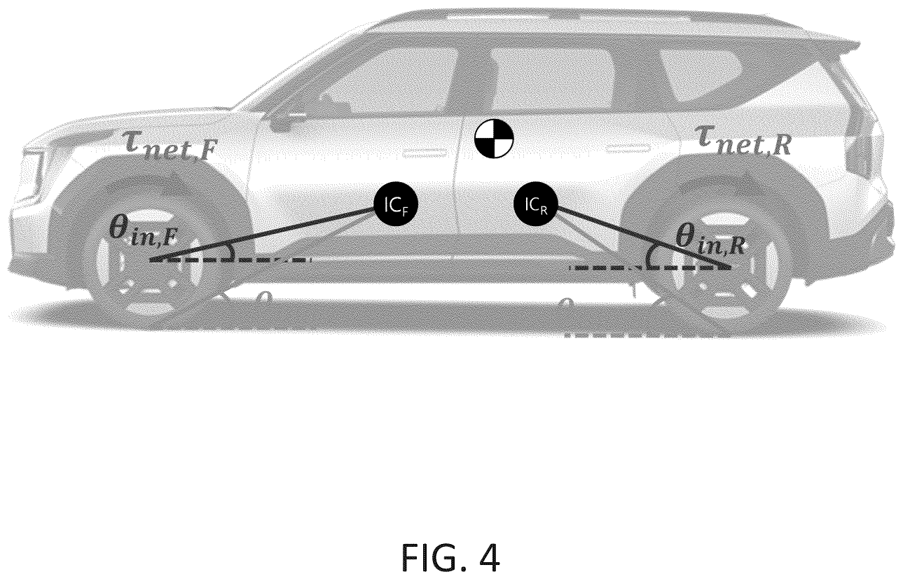

In the event of a braking scenario, Equations 3-9 may be used to estimate the CG of the vehicle in the z-direction.

$${z}_{CG} = 0.5 \cdot [ \frac{- ( Δ {F}_{z , susp , F} + Δ {F}_{z , Kin , F} ) \cdot L}{( τ \cdot {r}_{tire} - {F}_{grade} - {F}_{RL} ) \cdot {m}_{s}} + \frac{( Δ {F}_{z , susp , R} + Δ {F}_{z , Kin , R} ) \cdot L}{( τ \cdot {r}_{tire} - {F}_{grade} - {F}_{RL} ) \cdot {m}_{s}} ] \qquad Equation 3$$

$$Δ {F}_{z , susp} = {\sum }_{n = FL , FR or RL , RR} ( Δ {F}_{z , Spring , n} ) \qquad Equation 4$$

$$Δ {F}_{z , Spring , n} = ( {s}_{static , n} - {s}_{τ , n} ) \cdot {K}_{susp , n} \qquad Equation 5$$

$$Δ {F}_{z , Fin} = {\sum }_{n = FL , FR or RL , RR} Δ {F}_{z , K , Out , n} + Δ {F}_{z , K , in , n} \qquad Equation 6$$

$$Δ {F}_{z , K , Out , n} = ( {τ}_{LinBrk , n} ) \cdot {r}_{tire} \cdot tan ( {θ}_{out , n} ) \qquad Equation 7$$

$$Δ {F}_{z , K , in , n} = ( {k}_{FD , n} \cdot {τ}_{MG , n} ) \cdot {r}_{tire} \cdot tan ( {θ}_{in , n} ) \qquad Equation 8$$

$$τ = {k}_{FD , F} \cdot {τ}_{{MG}_{F}} + {k}_{FD , R} \cdot {τ}_{{MG}_{R}} + {τ}_{LinBrk} \qquad Equation 9$$

Where mₛ is the sprung mass (measured using the one or more stroke sensors), rₜᵢᵣₑ is the tire radius (assumed as a known value), F_{grade} is the force from the road (assumed as a known value), F_{RL} is the force from road loads (e.g., aerodynamic drag, rolling resistance, etc.) (assumed as a known value), K_{susp,n} is the suspension coil spring rate (specific to vehicle design and generally known by the original equipment manufacturer (OEM)), IC is the instantaneous center of pitch for each axle (specific to vehicle design and generally known by the OEM), θᵢₙ is the inclination to IC for inboard torque sources, θₒᵤₜ is the inclination to IC for outboard torque sources, and k_{FD} is the final drive ratio (specific to vehicle design and generally known by the OEM), as shown, e.g., in FIG. 4.

When the vehicle is not stopped (i.e., when the vehicle is no longer at rest), it may be determined, at 240, whether are enough data points in the Fz_AxleEvent to have a statistically meaningful sample (i.e., the number of data points in the Fz_AxleEvent is greater than a threshold).

When there are enough data points in the Fz_AxleEvent to have a statistically meaningful sample, then, at 218, a median value of each column in the Fz_AxleEvent may be calculated and added/appended to another Nx2 array called a Fz_AxleTrip, at 242. The Fz_AxleTrip is an array of the median estimates for each stopped event for a trip. According to an exemplary embodiment, a running median may be re-evaluated/calculated, at 244, each time a new value is added to the array, calculating the trip median for z_{CG,F} and z_{CG,R}. It may be set that any static loading conditions have been evaluated, at 246, and the Fz_AxleEvent and the number of data points in the Fz_AxleEvent may be reset, at 248.

When there are not enough data points in the Fz_AxleEvent to have a statistically meaningful sample, then, at 248, the Fz_AxleEvent and the number of data points in the Fz_AxleEvent may be reset.

At 250, it may be determined whether any static loading conditions have not been evaluated. When any static loading conditions have not been evaluated, then, at 204, it may be determined whether a vehicle is stopped (i.e., whether the vehicle's speed is zero). When any static loading conditions have been evaluated, then, at 228, it may be determined whether there are any static loading conditions (e.g., whether the vehicle is in park, whether a door is open (a significant change in estimated mass or distribution may occur after a door had been opened), and/or other static loading conditions). When there are any static loading conditions then, at 230, the CGz_Trip, an array which, assuming conditions are met, appends the median value of the latest CGz_Event (an array to log the estimated z component of the CG location during each timestep of a longitudinal dynamic event), and the Fz_AxleTip may be reset and it may then be determined, at 232, it may be set that any static loading conditions have not been evaluated.

When there are not any static loading conditions then it may then be determined, at 254, whether there is a longitudinal dynamic event. According to an exemplary embodiment, vertical position estimation may utilize results from the CG_{X/Y} estimations to establish a baseline static loading on each wheel of the vehicle. The baseline static loading on each wheel may then be used to determine a load transfer during longitudinal dynamic events (e.g., accelerating events, braking events, etc.).

When there is a longitudinal dynamic event, then, at 256, a vertical load (i.e., a load placed on the tires/wheels) may be estimated for a current timestamp. According to an exemplary embodiment, wheel displacement from one or more stroke sensors 104 may be read and, using known parameters such, e.g., spring and anti-rollbar (ARB) stiffnesses, the vertical load on each tire may be estimated. Processing of the data may comprise using basic statistics to filter out abnormalities such as movement in cabin and uneven road surfaces. According to an exemplary embodiment, torque estimations 258 and suspension kinematics 260 may be incorporated in estimating the vertical load.

At 208, a correction to the vertical load may be made based on the road grade or slope. According to an exemplary embodiment, the road's slope, the road's banking, the vehicle's speed, and the vehicle's mass may be known or measured using suitable means. According to an exemplary embodiment, an IMU 118 may be used to estimate an angle of the vehicle based, e.g., on finding the component of the gravitational acceleration that has “leaked” into the X- and Y-axis and/or via other suitable means (e.g., map and location data, etc.). This estimated vertical load may then be used to calculate the estimated z_{CG,F} and z_{CG,R} using a basic sum of forces and sum of moments calculations, at 262, to estimate the CG in the z-direction, at 264, by calculating an average CG for each axle, which may then be appended, at 266, into the CGz_Event. It may then be determined, at 254, whether there is a longitudinal dynamic event.

When there is no longitudinal dynamic event (e.g., when the vehicle is at rest), it may be determined, at 240, whether are enough data points in the CGz_Event to have a statistically meaningful sample (i.e., the number of data points in the CGz_Event is greater than a threshold).

When there are enough data points in the CGz_Event to have a statistically meaningful sample, then, at 218, a median value of each column in the CGz_Event may be calculated and added/appended to another Nx2 array called a CGz_Trip, at 270. The CGz_Trip is an array of the median estimates for each stopped event for a trip. According to an exemplary embodiment, a running median may be re-evaluated/calculated, at 272, each time a new value is added to the array, calculating the trip median for z_{CG,F} and z_{CG,R}. The CGz_Event and the number of data points in the CGz_Event may be reset, at 274.

When there are not enough data points in the CGz_Event to have a statistically meaningful sample, then, at 272, the CGz_Event and the number of data points in the CGz_Event may be reset and, at 204, it may be determined whether a vehicle is stopped (i.e., whether the vehicle's speed is zero).

The CG location on the vehicle effects vehicle dynamics and may be used in calculating and adjusting one or more vehicle control factors.

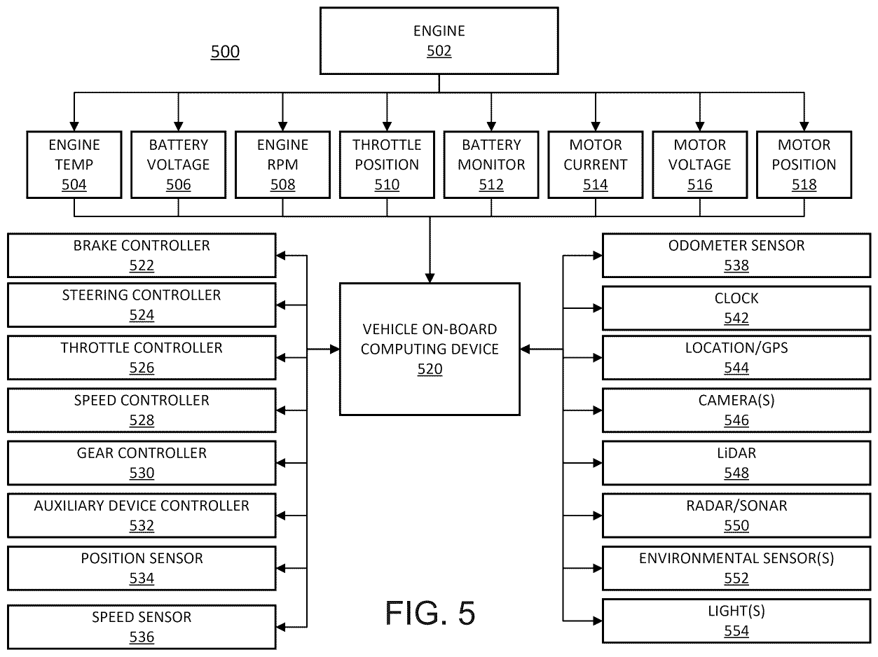

Referring now to FIG. 5, an example vehicle system architecture 500 for a vehicle is provided, in accordance with an exemplary embodiment of the present disclosure. The following discussion of vehicle system architecture 500 is sufficient for understanding one or more components of vehicle 102.

As shown in FIG. 5, the vehicle system architecture 500 may comprise an engine, motor or propulsive device 502 and various sensors 504-518 for measuring various parameters of the vehicle system architecture 500, such as, but not limited to, those of the vehicle snapshot described above. In gas-powered or hybrid vehicles having a fuel-powered engine, the sensors 504-518 may comprise, for example, an engine temperature sensor 504, a battery voltage sensor 506, an engine Rotations Per Minute (RPM) sensor 508, and/or a throttle position sensor 510. If the vehicle is an electric or hybrid vehicle, then the vehicle may comprise an electric motor, and accordingly may comprise sensors such as a battery monitoring system 512 (to measure current, voltage and/or temperature of the battery), motor current 514 and voltage 516 sensors, and motor position sensors such as resolvers and encoders 518.

Operational parameter sensors that are common to both types of vehicles may comprise, for example: a position sensor 534 such as an accelerometer, gyroscope and/or inertial measurement unit; a speed sensor 536; and/or an odometer sensor 538. The vehicle system architecture 500 also may comprise a clock 542 that the system uses to determine vehicle time and/or date during operation. The clock 542 may be encoded into the vehicle on-board computing device 520, it may be a separate device, or multiple clocks may be available.

The vehicle system architecture 500 may comprise various sensors that operate to gather information about the environment in which the vehicle is traveling. These sensors may comprise, for example: a location sensor 544 (for example, a Global Positioning System (GPS) device); object detection sensors such as one or more cameras 546; a LIDAR sensor system 548; and/or a radar and/or a sonar system 550. The sensors may comprise environmental sensors 552 such as, e.g., a humidity sensor, a precipitation sensor, a light sensor, and/or ambient temperature sensor. The object detection sensors may be configured to enable the vehicle system architecture 500 to detect objects that are within a given distance range of the vehicle in any direction, while the environmental sensors 552 may be configured to collect data about environmental conditions within the vehicle's area of travel. According to an exemplary embodiment, the vehicle system architecture 500 may comprise one or more lights 554 (e.g., headlights, flood lights, flashlights, etc.).

During operations, information may be communicated from the sensors to an on-board computing device 520 (e.g., computing device 108, processor 110, memory 112, and computing device 600). The on-board computing device 520 may be configured to analyze the data captured by the sensors and/or data received from data providers and may be configured to optionally control operations of the vehicle system architecture 500 based on results of the analysis. For example, the on-board computing device 520 may be configured to control: braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions); and/or other controllers. The brake controller 522 may comprise a pedal effort sensor, pedal effort sensor, and/or simulator temperature sensor, as described herein.

Geographic location information may be communicated from the location sensor 544 to the on-board computing device 520, which may then access a map of the environment that corresponds to the location information to determine known fixed features of the environment such as streets, buildings, stop signs and/or stop/go signals. Captured images from the cameras 546 and/or object detection information captured from sensors such as LiDAR 548 may be communicated from those sensors to the on-board computing device 520. The object detection information and/or captured images may be processed by the on-board computing device 520 to detect objects in proximity to the vehicle. Any known or to be known technique for making an object detection based on sensor data and/or captured images may be used in the embodiments disclosed in this document.

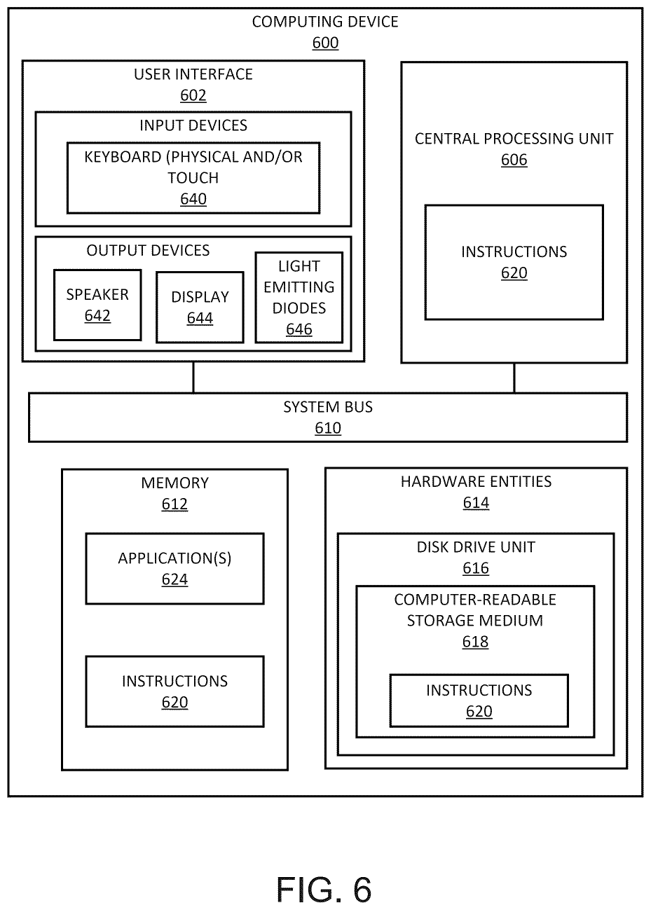

Referring now to FIG. 6, an illustration of an example architecture for a computing device 700 is provided. According to an exemplary embodiment, one or more functions of the present disclosure may be implemented by a computing device such as, e.g., computing device 600 or a computing device similar to computing device 600. Computing device 600 may be a quantum computer, a classical computer, and/or have one or more components configured to perform one or more quantum and/or classical computing functions. Computing device 222, processor 224, memory 226, and/or computing device 520 may be an example of computing device 600 and/or may comprise one or more components of computing device 600.

The hardware architecture of FIG. 6 represents one example implementation of a representative computing device configured to implement at least a portion of the systems/devices (e.g., vehicle 102) and method(s)/control logic(s) (e.g., method 200) described herein.

Some or all components of the computing device 600 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 6, the computing device 600 may comprise a user interface 602 (e.g., a graphical user interface), a Central Processing Unit (“CPU”) 606, a system bus 610, a memory 612 connected to and accessible by other portions of computing device 600 through system bus 610, and hardware entities 614 connected to system bus 610. The user interface may comprise input devices and output devices, which may be configured to facilitate user-software interactions for controlling operations of the computing device 600. The input devices may comprise, but are not limited to, a physical and/or touch keyboard 640. The input devices may be connected to the computing device 600 via a wired or wireless connection (e.g., a Bluetooth® connection). The output devices may comprise, but are not limited to, a speaker 642, a display 644, and/or light emitting diodes 646.

At least some of the hardware entities 614 may be configured to perform actions involving access to and use of memory 612, which may be a Random Access Memory (RAM), a disk driver and/or a Compact Disc Read Only Memory (CD-ROM), among other suitable memory types. Hardware entities 614 may comprise a disk drive unit 616 comprising a computer-readable storage medium 618 on which may be stored one or more sets of instructions 620 (e.g., programming instructions such as, but not limited to, software code) configured to implement one or more of the methodologies, procedures, or functions described herein. The instructions 620 may also reside, completely or at least partially, within the memory 612 and/or within the CPU 606 during execution thereof by the computing device 600.

The memory 612 and the CPU 606 may also constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding, or carrying a set of instructions 620 for execution by the computing device 600 and that cause the computing device 600 to perform any one or more of the methodologies of the present disclosure. According to various embodiments, one or more computer applications 624 may be stored on the memory 612.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for estimating a center of gravity (CG) for a vehicle, the method comprising:
a) estimating a longitudinal CG and a lateral CG of the vehicle; and
b) estimating a vertical CG of the vehicle,
to thereby estimate a center of gravity (CG) for the vehicle using a computing device.

2. A method for estimating a center of gravity (CG) for a vehicle, the method comprising:
a) estimating a longitudinal CG and a lateral CG of the vehicle, comprising:
i) determining, using a computing device comprising a processor and a memory, whether the vehicle is stopped;
ii) when the vehicle is stopped, estimating a vertical load on the vehicle;
iii) estimating the longitudinal CG of the vehicle based on the vertical load; and
iv) estimating the lateral CG of the vehicle based on the vertical load; estimating a vertical CG of the vehicle, comprising:
v) determining, using the computing device, whether there is a longitudinal dynamic event happening to the vehicle;
vi) when there is a longitudinal dynamic event happening to the vehicle, estimating a vertical load on a front axle of the vehicle and a rear axle of the vehicle;
vii) estimating a front vertical CG of the vehicle based on the vertical load on the front axle;
viii) estimating a rear vertical CG of the vehicle based on the vertical load on the rear axle; and
ix) averaging the front vertical CG of the vehicle and the rear vertical CG of the vehicle to estimate the vertical CG of the vehicle.

3. The method of claim 2, further comprising determining whether the vehicle is in drive.

4. The method of claim 2, wherein the estimating the vertical load on the vehicle, when the vehicle is stopped, comprises measuring wheel displacement from one or more stroke sensors coupled to the vehicle.

5. The method of claim 2, wherein the estimating the longitudinal CG and the lateral CG of the vehicle comprises performing a vertical load correction based on one or more of the following:
a slope of the vehicle;
a banking of a road on which the vehicle is driving;
a speed of the vehicle; and
a mass of the vehicle.

6. The method of claim 2, wherein the estimating the vertical CG of the vehicle comprises estimating, using the computing device, one or more static loading conditions.

7. The method of claim 2, wherein the estimating the vertical load on the vehicle, when there is a longitudinal dynamic event happening to the vehicle, comprises measuring wheel displacement from one or more stroke sensors coupled to the vehicle.

8. The method of claim 2, wherein the longitudinal dynamic event comprises one or more of:
a braking event; and
an accelerating event.

9. The method of claim 2, wherein the vehicle comprises an electric vehicle.

10. A system for estimating a center of gravity (CG) for a vehicle, the system comprising:
a vehicle; and
a computing device comprising a processor and a memory,
wherein the memory is configured to store instructions that, when executed by the processor, are configured to cause the processor to:
estimate a longitudinal CG and a lateral CG of the vehicle, comprising:
determining, using a computing device comprising a processor and a memory, whether the vehicle is stopped;
when the vehicle is stopped, estimating a vertical load on the vehicle;
estimating the longitudinal CG of the vehicle based on the vertical load; and
estimating the lateral CG of the vehicle based on the vertical load; and
estimate a vertical CG of the vehicle, comprising:
determining, using the computing device, whether there is a longitudinal dynamic event happening to the vehicle;
when there is a longitudinal dynamic event happening to the vehicle, estimating a vertical load on a front axle of the vehicle and a rear axle of the vehicle;
estimating a front vertical CG of the vehicle based on the vertical load on the front axle;
estimating a rear vertical CG of the vehicle based on the vertical load on the rear axle; and
averaging the front vertical CG of the vehicle and the rear vertical CG of the vehicle to estimate the vertical CG of the vehicle.

11. The system of claim 10, wherein the instructions, when executed by the processor, are further configured to cause the processor to determine whether the vehicle is in drive.

12. The system of claim 10, further comprising one or more stroke sensors coupled to the vehicle.

13. The system of claim 12, wherein the estimating the vertical load on the vehicle, when the vehicle is stopped, comprises measuring wheel displacement from the one or more stroke sensors coupled to the vehicle.

14. The system of claim 12, wherein the estimating the vertical load on the vehicle, when there is a longitudinal dynamic event happening to the vehicle, comprises measuring wheel displacement from the one or more stroke sensors coupled to the vehicle.

15. The system of claim 10, wherein the estimating the longitudinal CG and the lateral CG of the vehicle comprises performing a vertical load correction based on one or more of the following:
a slope of the vehicle;
a banking of a road on which the vehicle is driving;
a speed of the vehicle; and
a mass of the vehicle.

16. The system of claim 10, wherein the estimating the vertical CG of the vehicle comprises estimating, using the computing device, one or more static loading conditions.

17. The system of claim 10, wherein the longitudinal dynamic event comprises one or more of:
a braking event; and
an accelerating event.

18. The system of claim 10, wherein the vehicle comprises an electric vehicle.
